(19) United States
(12) Patent Application Publication
(10) Pub. No.: US 2005/0017869 A1
(43) Pub. Date: Jan. 27, 2005

(54) Device and method for alerting a person to the presence of a door

(76) Inventor: Robert S. Fielmann, Riverside, IL (US)

Correspondence Address: Ryndak & Suri, Suite 2630, 30 North LaSalle Street, Chicago, IL, 60602, US

(21) Appl. No.: 10/627,909

(22) Filed: Jul. 25, 2003

(51) Int. Cl. G08B 21/00

(52) U.S. Cl. 340/686.6

(57) ABSTRACT

A safety device and method is provided for warning a person of the presence of a substantially transparent door or window. The safety device includes a short-range detector, which can be a motion detector that causes activation of an audible alarm device that forms part of the safety device to warn a person of the presence of the door or window to thereby prevent an unwanted collision between the door or window and the person.

### FIELD OF THE INVENTION

This invention relates generally to the field of personal safety. More specifically this invention relates to a method and device that automatically warns a person approaching a substantially transparent or transparent panel of a door to the presence of the door so that the person can avoid a collision with the door.

### BACKGROUND OF THE INVENTION

In the past, doors were usually constructed of wood or other non-transparent materials. While some doors had windowpanes, a substantial portion of the door was non-transparent. Consequently, it was readily apparent to a person approaching the door that it was either open or closed. With the advent of patio doors, a substantial area of the door is composed of a large glass panel, often without mullions. Hinged or sliding patio doors are frequently accompanied by screen doors that have expansive screen panels that are substantially transparent. Also, large, expansive glass panel windows are found in many buildings, both commercial and residential. The use of expansive, transparent panels in windows or doors give a feeling of spaciousness, to maximize natural lighting, and can provide a beautiful view. Thus, they can be aesthetically pleasing.

However, such screen and glass doors or expansive glass panels have several drawbacks. Safety is of particular concern. People can be severely injured when they attempt to walk through such doors or expansive glass panels, such as when they do not realize that the door is closed. These accidents can occur because inattentive, absent-minded, or distracted people do not see or otherwise realize that the door or expansive glass panel is present in a closed position because it is transparent or substantially transparent.

Therefore, a need exists for an active (i.e. non-passive) method and device that warns the person of the presence of a door (typically a closed door) or a large, transparent window or panel so that collisions with a transparent or substantially transparent door are reduced, while minimizing the interruption of the view through the door or improving the aesthetic appeal of such doors.

### SUMMARY OF THE INVENTION

In accordance with the present invention, a safety device is provided that comprises a detector with a range of less than about 5 feet and an audible alarm device. The safety device is mounted on or in close proximity to a transparent or substantially transparent door. When a person is near the door, that person is detected by the detector. In response to the detection, the audible alarm device emits an audible warning that actively alerts the person to the presence of the door. The alerted person can then stop or slow down and check to see if the door is closed or is otherwise in the person's path of travel thereby reducing the likelihood of an unintended or unwanted collision between the person and the door. In accordance with one embodiment of the invention, the detector is a motion detector.

The safety device typically is incorporated into a housing that contains the detector and audible alarm device can be mounted in any suitable manner so that it is in close proximity to the door or substantially transparent panel. In one embodiment, the device is contained in a pouch, which is mounted on or in close proximity to a door.

In accordance with another embodiment of the invention, the detector is a body heat sensitive detector.

In accordance with another embodiment of the invention, when a person is detected, the audible alarm device plays a user's warning recorded by a recording device. This embodiment also has at least one magnetic member which allows the safety device to be mounted and dismounted easily onto a door.

In accordance with another embodiment of the invention, the detector has a controller to control the detection range of the detector.

In accordance with another embodiment of the invention, the safety device includes a housing that contains the detector, a self-contained power supply, and the audible alarm device.

In accordance with another embodiment of the invention, the safety device is held by an attractively shaped pouch or other suitable structure for holding or supporting the device. The pouch or other structure is mounted on or in close proximity to a transparent or substantially transparent door for which detection is desired. The pouch or other structure can be in any kind of desired shape or image, including animals, such as a fish or bird, scenery, holiday motifs, famous paintings, etc. The attractive shape provides a visual indication of the door.

In accordance with another embodiment of the invention, the device employs a detector, which can be a motion detector and audible alarm device. The volume of the audible alert emitted by the audible alarm device is controlled by a volume control device. The audible alarm device is configured so that when the detector detects motion continuously, after a predetermined period of time, the audible alarm device ceases to give an audible warning. The audible alarm device can be configured to reset itself when the detector stops detecting motion and can give an audible warning when motion is detected again.

Another aspect of this invention provides a method for warning a person of the presence of a door or substantially transparent panel (i.e., a window) comprising the steps of mounting a device that comprises a detector and an audible alarm device, on or in close proximity to a transparent or substantially. transparent door or window, sending a close proximity detection signal from the detector to detect the presence of a person, and automatically generating an audible warning by the audible alarm device in response to a detected person. The detector typically has a range of less than about 5 feet and can be a motion detector or a heat detector suitable for detecting the body heat of an individual person when in close proximity to the detector.

### BRIEF DESCRIPTION OF THE DRAWINGS

The present invention can be more readily understood by reference to the accompanying drawings, which are given by way of illustration only, and thus are not limitative of the present invention, and wherein:

FIG. 1 is a front view of an embodiment of the safety device installed next to a patio door warning a person, otherwise oblivious of the door;

FIG. 2 shows the safety device mounted onto a patio door from the front;

FIG. 3 is a sectional view of the detector and door of FIG. 2 along the lines 3-3;

FIG. 4 shows the front of the safety device (front elevation view);

FIG. 5 shows the back of the safety device (rear elevation view);

FIG. 6 shows the safety device and a pouch mounted onto a glass panel;

FIG. 7 is a sectional view the pouch and door of FIG. 6 along the lines 7-7;

FIG. 8 shows the safety device contained in a pouch, which looks like a bird;

FIG. 9 shows the safety device contained in a pouch, which looks like a fish;

FIG. 10 is an exploded view of the safety device mounted to a screen; and

FIG. 11 describes the interrelationships in block diagram of the preferred embodiment of the safety device.

### DETAILED DESCRIPTION OF THE INVENTION

Referring to the FIGURES generally, where like reference numerals refer to like elements, and in particular to FIG. 1, a safety device 20 is for actively warning a person P approaching an at least substantially transparent door 22 or window 24 of the presence of door 22 or window 24. A door or window that is not at least substantially transparent usually does not need safety device 20 because the opaqueness of the door is sufficient to indicate the presence of the door. However, use of safety device 20 is not limited to substantially transparent doors and windows and can be desirable for buildings serving the visually impaired and highly distracted people, for example.

Examples of an at least substantially transparent door 22 include a patio door, which typically has a relatively narrow frame 28d and relatively large glass panel 26d, frameless glass doors, screen doors, etc. Examples of an at least substantially transparent window 24 include the stationary panel of a patio door, which typically has a relatively narrow frame 28w and a relatively large glass panel 26w, tall windows which are not necessarily adjacent to a door and screens over a large open window, for example.

Referring to FIG. 4 and FIG. 11, which shows the interrelationships of some of the components of safety device 20 in block diagram form, safety device 20 includes a detector 40, an optional range adjustment controller 42 which can also include an on-off switch, an audible alarm 102, an optional record button 44, an optional tape recorder 104 and optionally a separate on-off switch (not shown), all contained within an optional housing 46. Housing 46 is made of a durable material such as plastic, metal, etc. If safety device 20 is meant for outdoor installation, housing 46 preferably should be water- and insect-resistant. If safety device 20 is to be mounted on a sliding door, it should be relatively thin so it does not impede the opening and closing of the door.

Detector 40 can be a variety of different detectors including a body heat sensitive detector and preferably a motion detector. It may detect using electromagnetic or ultrasonic signals 30 emitted from the detector and reflecting off 31 of person P, as shown in FIG. 1, or it may detect infrared radiation emanating from person P. An advantage of having detector 40 emit a close proximity signal is that spurious warnings are not sounded (i.e., if a person is in the room but more than about 5 feet from the detector). All of the referenced detectors are well known in the art and consequently are not described in detail herein.

The detection range of detector 40 of device 20 can be controlled by a suitable range adjustment controller 42. The detection range may extend to about 5 feet or more. The preferred detection range may be varied between 1 and 3 feet or more in 1-foot increments using range adjustment controller 42. Range adjustment controller 42 may control a sensitivity setting for detector 40 or the strength of close proximity emitted signals from detector 40. A short detection range is preferred to prevent “false alarms.” It is typically not necessary or desirable to audibly alert person P of the presence of the door when person P is at a distance of more than about 5 feet from the door, since person P may be walking without intending to approach the door or window that is associated with device 20. Detection ranges less than 5 feet are especially desirable to minimize false alarms when there is much foot traffic that passes by, but not through door 22.

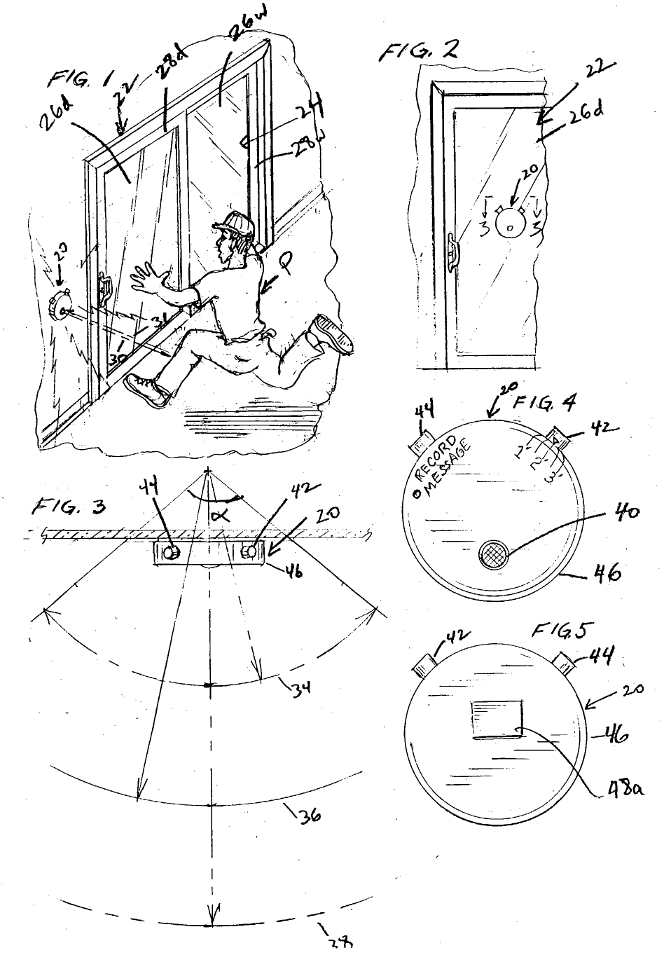

Referring to FIG. 3, depending on the particular type of detector, the volume where person P is detected by detector 40 can be defined by an angle of detection α (assuming a conical rather than oval or square detector range), defined by the vertex of angle 32, an orientation line perpendicular to the detector and passing through the center of the detector and vertex 32, which is in the middle of the detection volume, and a detection range (detection ranges 34, 36, and 38 of 1, 2, and 3 feet, respectively, are illustrated). It is desirable to detect person P in an area in front of door 22 and to minimize the coverage of areas not in front of door 22 so as to minimize the problem of false detections and alarms described above. This is most readily achieved by mounting safety device 20 at or near the horizontal center of door 22 (see FIG. 2), between two panels 26d and 26w to protect door 22 and window 24, or in close proximity to door 22 (see FIG. 1). The distance safety device 20 can be installed away from door 22 depends on safety device 20's detection volume. The orientation of safety device 20 may be adjustable so it can point in the direction of the front of the door when it is not mounted onto the door. Detector 40 detects motion 100 and includes a range adjustment controller 42.

Referring to FIG. 11, detector 40 controls audible alarm 102. Audible alarm 102 can be any kind of device that emits an audible warning such as a piezoelectric buzzer, a sound generator and speaker, a mechanical bell, a playback device for playing recorded messages, etc. In an alternative embodiment, the audible alarm includes an audible alarm device which can also signal a recorder/playback device 104 to play a recorded warning message. In one embodiment of the invention, the warning message can be recorded by a recorder 104 when the user presses record button 44. Recorder 104, such as a digital recorder or tape recorder, can be used to record and playback messages by the user. The recorder may use a microphone, such as a built-in microphone, external microphone, or even the recorder's speaker to record a user's message. A volume control (not displayed) is not necessary when the buzzer provides all or part of the only audible warning. If only a user-recorded message is played as a warning, a volume control is preferred to ensure that the message is sufficiently loud to warn person P. Volume control devices are well known in the art and are not further described herein.

The preferred embodiment has a self-contained power supply (not displayed) such as a 9-volt alkaline battery within housing 46. Alternatively the detector can have an exterior power supply such as an AC/DC adapter.

Safety device 20 can be mounted to a wall or door by any suitable structure known in the art. Examples of permanent mounting structures include screws, nails, tape and glue, for example. However, safety device 20 is preferably removably mounted. FIG. 5 shows a magnetic element 48a on the back of safety device 20. In FIG. 10, safety device 20 is mounted onto a screen door by aligning magnetic element 48a and a second magnetic element 48b immediately opposite each other on opposite sides of a screen 62 of the screen door. Either one or both of the magnetic elements can be a magnet. If only one of the magnetic elements is a magnet, the other magnetic element is ferromagnetic. This method of mounting can also be employed for glass panel 26.

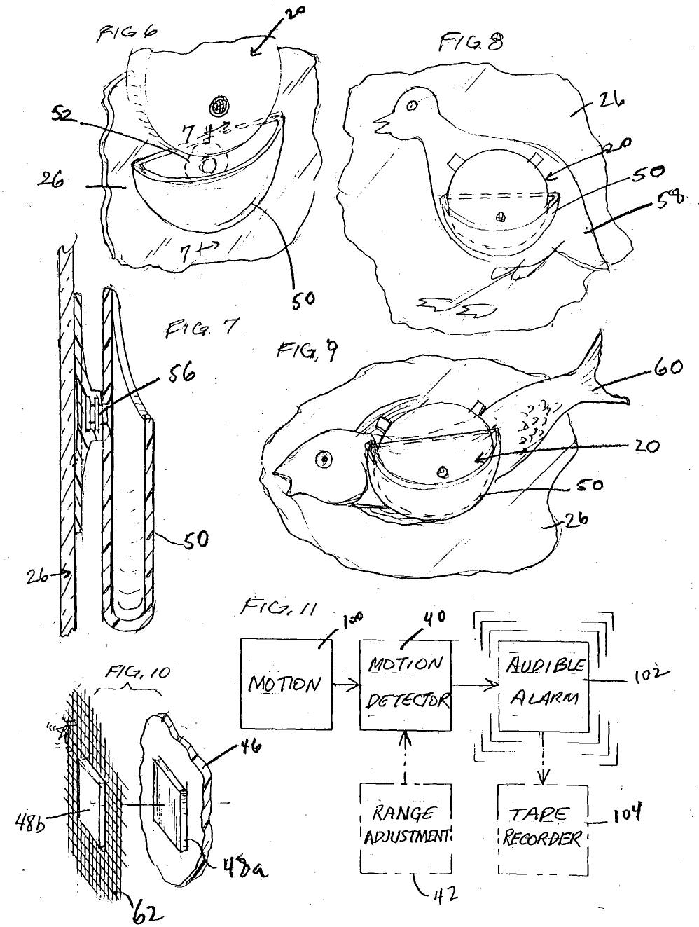

In FIG. 6, safety device 20 is illustrated as being held in a pouch 50, which is mounted to glass panel 26 by a suction cup 52. FIG. 7 shows a swivel 56, which allows the pouch to swivel downwardly to securely hold safety device 20. FIGS. 8 and 9 show safety device 20 contained in pouch 50, which can be in the overall shape of a bird aesthetic 58 or a fish aesthetic 60, for example, or any other desired shape, preferably removably mounted to glass panel 26. The aesthetics provide an appealing whimsical element, which also can passively indicate the presence of the door to the user. The aesthetic can be inexpensive to manufacture. Consequently a user may purchase several aesthetics and change them to celebrate birthdays, holidays, or other events.

A typical application for safety device 20 is to provide warnings for patio doors. Referring to FIG. 1, a patio door typically has sliding door 22, a stationary panel or window 24, and a screen door (not shown). A user of safety device 20 first has to select what door or window needs safety device 20 and if both entry and exit through the selected door or window needs safety device 20. For example, stationary panel 24 may not need safety device 20 if a drapery typically covers stationary panel 24. Based on the selection of doors and windows to alarm, the user selects locations for the safety device 20. Ideally safety device 20 is mounted on approximately the horizontal center of door 22 or window 24. However that location may not be possible because there is not sufficient clearance for the sliding door. Alternatively that location may not be desirable because it impedes a view. Safety device 20 can also be placed above or to the side of door 22 or window 24, in close proximity thereto. The above location is generally not preferred unless the detection range extends to or beyond approximately 5 feet, because small children may not trigger audible alarm 102. A user might also decide to locate safety device 20 on a wall adjacent to door 22, rather than on door 22, because at that location safety device 20 can provide warnings for both a patio door and the accompanying screen door. In addition, a user may select a location near the middle of door 22 and window 24, so safety device 20 can provide warnings for both.

The user can mount safety device 20 at the location selected using any suitable structure known in the art. As discussed earlier, use of a removable mounting is preferred. Examples of removable mountings include suction cups, magnets, and pouches as discussed earlier.

Before or after mounting, the user can set various optional features of the safety device as described below. The user can record a warning message by pressing record button 44 while recording. The user can adjust the volume. The user can adjust the detection range and detector orientation. The user can orient the detector towards the area in front of door 22 or window 24. If mounted on or near the horizontal center of door 22 or window 24, the detector is oriented to point straight out from door 22 or window 24. The user can adjust the range. A shorter range is preferred when people-frequently pass in front of the door to avoid false alarms. A longer range is preferred when safety device 20 is not mounted to door 22 or window 24. Other considerations in adjusting the range include the amount of warning time desired and how well oriented the detector is.

When person P approaches door 22 or window 24 and enters the detection volume of safety device 20, which is mounted in at least close proximity to door 22 or window 24, detector 40 detects person P and signals audible alarm 102 to sound. In response to the detection signal, audible alarm 102 automatically generates an audible warning. The audible alarm can play any type of sound that denotes a warning such as a series of beeps, a series of rapid chimes, a siren sound, a warning message played by recorder/playback device 104, a combination of warning sounds, etc. Alerted by the audible alarm, person P looks to make sure that door 22 is open before proceeding. The recorded warning message can be a prerecorded message provided by the manufacturer, such as a humorous warning message by a celebrity, or a message recorded by the user.

In another embodiment, when detector 40 signals audible alarm 102, it signals a timer (not displayed) in audible alarm 102. The timer automatically resets itself when detector 40 stops signaling it. After a predetermined time period, the timer prevents audible alarm 102 from emitting an audible warning until the timer resets itself. This predetermined time may be user adjustable. Suitable timers, which are well known in the art, can be used. The timer feature shuts off audible alarm 102 after a predetermined period of time in response to detected motion and automatically resets safety device 20 once motion is no longer detected. This feature prevents a warning message from being played continuously when people are constantly standing near safety device 20. Such situations can arise during parties and other social gatherings.

The same goal can be achieved by turning off or removing safety device 20 temporarily during a social gathering. Removal of safety device 20 is easy if it has been removably mounted.

An intrinsic feature of safety device 20 is that it does not need a test button unlike a fire alarm. Safety device 20 can be tested by waving a hand in front of the motion detector.

Claim elements and steps herein have been numbered and/or lettered solely as an aid in readability and understanding. As such, the numbering and/or lettering in itself is not intended to and should not be taken to indicate the ordering of elements and/or steps in the claims.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A device for warning a person of the presence of a door when the person is in close proximity to the door, comprising:
a detector device, having a detection range of less than about 5 feet, for being positioned in at least close proximity to an at least substantially transparent door in a position to detect the person in close proximity to the door; and
an audible alarm device for providing an audible warning to the person in proximity to the door, the audible alarm device associated with the motion detector device so that the audible alarm device provides the audible warning in response to the detection of the person by the motion detector device to warn the person of the presence of the door.

2. The device of claim 1 wherein the detector device comprises a motion detector.

3. The device of claim 1 wherein the device comprises a body heat sensitive detector.

4. The device of claim 1 further comprising a recording device allowing the user of the device to record a desired audible warning, the audible alarm device emitting the desired audible warning in response to the detection of the person by the motion detector device to warn the person of the presence of the door.

5. The device of claim 2 further comprising a controller for the motion detector for adjusting the detection range of the motion detector device.

6. The device of claim 1 further comprising a housing that contains the detector device and the audible alarm device.

7. The device of claim 4 further comprising at least one magnetic member for removal by mounting the housing to the door.

8. The device of claim 2 further comprising a pouch for being mounted in at least close proximity to the door for containing the motion detector and the audible alarm device.

9. The device of claim 8 further comprising a housing that contains the motion detector and the audible alarm device.

10. The device of claim 1, further comprising a visually attractive shape carried by the pouch for providing a visual indication of the door to the person in proximity to the door.

11. The device of claim 6 further comprising a self-contained power supply contained in the housing for the motion detector device and the audible alarm device.

12. The device of claim 2, further comprising a volume control device associated with the audible alarm device for controlling the volume of the audible warning.

13. The device of claim 2, wherein the audible alarm device ceases to give an audible warning after a predetermined period of time in response to detected motion by the motion detector device and the audible alarm device resets itself when motion is no longer detected by the motion detector device.

14. A method for warning a person of the presence of a door when the person is in close proximity to the door, comprising:
mounting a device in at least close proximity to an at least substantially transparent door for detecting a person in close proximity to the door, the device comprising a motion detector device having a range of less than about five feet and an audible alarm device for providing an audible warning to the person in proximity to the door, the audible alarm device associated with the motion detector device so that the audible alarm device provides the audible warning in response to the detection of the person by the motion detector device to warn the person of the presence of the door;
sending a close proximity detection signal from said motion detector device for detecting motion within close proximity of the door; and
automatically generating, from the audible alarm device, the audible warning in response to the detection of the person in close proximity to the door.

15. The method of claim 14, further comprising recording an audible warning provided by the user to be emitted by the audible alarm device in response to the detection of the person in close proximity to the door.

16. The method of claim 14, further comprising adjusting a controller for controlling the detection range of the motion detector.

17. The method of claim 14, wherein the mounting comprises removably mounting the device in at least close proximity to an at least substantially transparent door.

18. The method of mounting as recited in claim 17, wherein the removably mounting comprises placing the device in a pouch mounted in at least close proximity to an at least substantially transparent door.

19. The method of claim 14 further comprising:
shutting off the audible warning after a predetermined period of time in response to detected motion by the motion detector device; and
automatically resetting the audible warning device to provide an audible warning when motion is detected by the motion detector device.
